(19) United States
(12) Patent Application Publication
(10) Pub. No.: US 2009/0067650 A1
(43) Pub. Date: Mar. 12, 2009

(54) Method and arrangements for detecting the type of acoustic signal source with a hearing device

(75) Inventor: Thomas Kasztelan, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL INSTRUMENTS PTE. LTD.

(21) Appl. No.: 12/283,080

(22) Filed: Sep. 9, 2008

(30) Foreign Application Priority Data
Sep. 10, 2007 (DE) 10 2007 043 081.9

(51) Int. Cl. H04R 25/00

(52) U.S. Cl. 381/312

(57) ABSTRACT

The invention describes a method and associated arrangements for detecting the type of external acoustic sources with a hearing device. The external acoustic source, for instance a telephone, outputs at least one identification signal for this purpose, which designates the type of acoustic source. The hearing device detects the identification signal and evaluates this for an identification of the type of acoustic source. The hearing device is automatically switched over into an associated mode of operation on the basis of this information.

### CROSS REFERENCE TO RELATED APPLICATIONS

This application claims priority of German application No. 10 2007 043 081.9 DE filed Sep. 10, 2007, which is incorporated by reference herein in its entirety.

### FIELD OF INVENTION

The invention relates to a method for detecting the type of external acoustic source with a hearing device as well as arrangements for implementing the method according to the invention.

### BACKGROUND OF INVENTION

Hearing devices are equipped with different receive facilities, for instance microphone or telephone coil, and associated signal processing functions in order to make the signals from different types of sound-emitting signal sources optimally audible to a hearing device wearer. Numerous hearing devices are equipped with a button or a switch, with which the type of external acoustic source can be selected, in order to switch to these different receiver modes of operation.

The applicant's patent application DE 100 48 341 C5 specifies an MTO switch to be operated by the hearing device wearer for switching off a hearing aid device and/or hearing device and/or for selecting the signal reception by way of a microphone or a telephone coil.

### SUMMARY OF INVENTION

It is however often desirable, in terms of the user-friendliness of a hearing device, to automate a selection of this type.

It is thus the object of the invention to specify a method, which allows an automated switchover between different signal receptions and/or signal processings.

The set object is achieved in accordance with the invention by the method of the independent claims, by the type of external acoustic sources being detected for a switchover decision using a hearing device. To this end, at least one identification signal is emitted by an external acoustic source, said identification signal clearly specifying the type of acoustic source. The identification signal is detected by the hearing device and evaluated in order to identify the type of acoustic source.

This is advantageous in that the type of external acoustic sources is identified irrespective of a manual switch actuation.

In one development, a mode of operation of the hearing device can be assigned to any type of acoustic source, in which mode of operation it is possible for the hearing device to switch over in accordance with the type of acoustic source.

It is advantageous here that a mode of operation which corresponds to the acoustic signal can as a result be selected automatically.

In a further embodiment, the identification signal may be an acoustic or electromagnetic signal.

The identification signal can as a result be received by way of a microphone or a telephone coil of the hearing device.

In one development, it is possible to identify the type of acoustic source from the pulse frequency and pulse width of the identification signal.

This is advantageous in that it renders a simple and reliable evaluation of the identification signal possible.

In a further embodiment, the types comprising telephone device, audio device and MLX device can in particular be detected.

Important hearing device modes of operation are detected as a result.

A further object of the invention consists in specifying an apparatus associated with the method according to the invention.

In accordance with the invention, the set object is achieved with the arrangements and/or apparatuses of the independent claims.

In accordance with the invention, the arrangement includes a hearing device for detecting the type of external acoustic sources in which an identification module is arranged. This can detect at least one identification signal which is output by the external acoustic source and specifies the type of acoustic source and evaluates it in order to identify the type of acoustic source.

In one development, the identification model can detect the type of acoustic source from the pulse frequency and pulse width of the identification signal.

A further inventive arrangement includes an identification generation apparatus for an external acoustic source, which generates an identification signal, which can be received and evaluated by a hearing device according to the invention.

External acoustic sources can as a result be easily retrofitted.

In one development the identification generation apparatus can be integrated in an anti-twist device in a telephone receiver cord.

This has the advantage of being cost-effective to manufacture and simple to assemble.

In a further embodiment, the identification generation apparatus can be integrated in a memory card of a mobile telephone.

As a result, mobile telephones can also bring about an automatic mode of operation switchover.

Furthermore, an inventive system for detecting the type of external acoustic sources is specified. This includes a hearing device with an identification module and an external acoustic source with an identification generation apparatus.

### BRIEF DESCRIPTION OF THE DRAWINGS

Further details of the invention are apparent from the explanations of several exemplary embodiments below, with reference to schematic drawings, in which;

FIG. 1: shows a flowchart of the method according to the invention,

FIG. 2: shows a hearing device,

FIG. 3: shows a block diagram of a hearing device and

FIG. 4: shows an arrangement with a telephone handset.

### DETAILED DESCRIPTION OF INVENTION

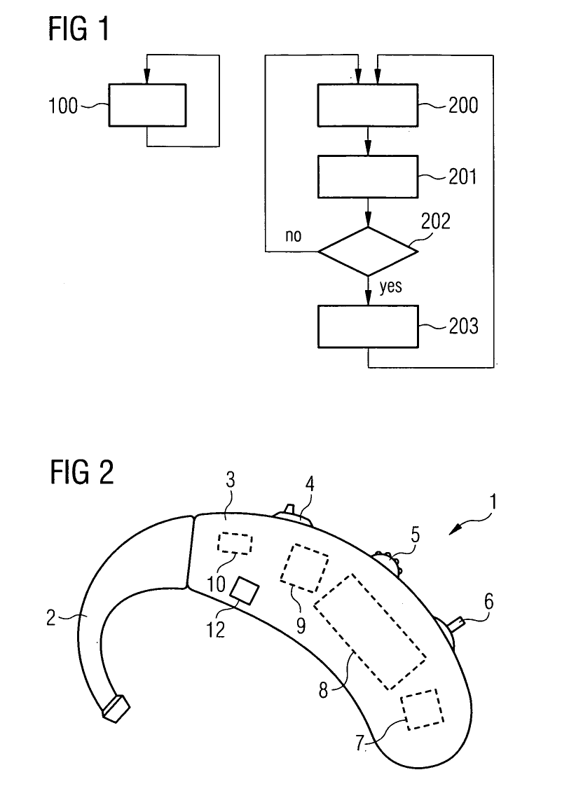

FIG. 1 shows the course of the method according to the invention in the form of a diagram. This method is implemented with the apparatus elements shown in FIG. 4. In step 100, an external acoustic source 16, also referred to as acoustic signal source, repeatedly outputs an identification signal 21. This is detected in step 200 by a hearing device 1 and is evaluated in the following step 201. The evaluation identifies the type of acoustic source 16 on the basis of the identification signal 21 which is output by the acoustic source 16. In step 202, a comparison is now made to determine whether the detected type corresponds with the mode of operation used by hearing device 1. If the comparison is negative, step 200, in other words the detection process, is repeated. If the result is positive, step 203 follows, in which the hearing device 1 switches over to the mode of operation which corresponds to the acoustic source 16. Step 200 is then repeated and the method sequence starts from the beginning.

The inventive method proceeds continuously in the background without a hearing wearer being influenced thereby. For instance the identification signal is distributed every second for a couple of milliseconds. This thus ensures that the optimum mode of operation is always switched on.

A hearing device which is suited to the method is shown in FIG. 2. The hearing device 1 according to FIG. 2 which can be worn behind the ear includes an ear wearing hook 2 and a base unit 3. The base unit 3 includes an MTO switch 6 for switching off the hearing device 1 and for manually selecting the mode of operation of the signal reception by way of an integrated microphone 10 or an integrated telephone coil 12, a volume controller 5 as well as a program selection button 4 for setting different audio programs. The hearing device 1 for signal processing also has a signal processing unit 8. In order to adjust the hearing device 1 to different hearing situations, different parameter sets of the signal processing unit 8 can be activated. For the automatic selection of an audio program and thus of a parameter set for the signal processing unit 8, the output signal of the microphone 10 is analyzed. The preamplifier 9 amplifies the signal of the microphone 10 before it is supplied to the signal processing unit 8. The signal which is processed and amplified by the signal processing unit 8 is output as an acoustic signal by way of the receiver 7.

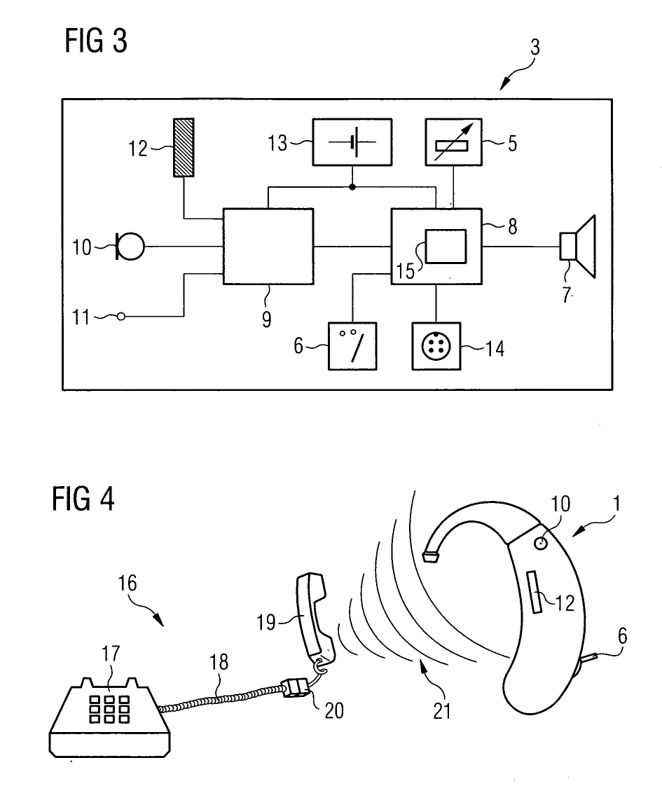

In order to automatically identify the mode of operation, an identification module 15 (not shown in FIG. 2 and described in more detail in FIG. 3) is arranged in the signal processing unit 8, said identification module 15 identifying the type of external acoustic source 16 (not shown) which corresponds to the method according to FIG. 1 and triggers the hearing device 1 in accordance with the identified type to switch over to the associated mode of operation.

The base unit 3 of a hearing device 1 which is shown schematically in FIG. 3 on the basis of a circuit diagram has a microphone 10, an audio input 11 and a telephone coil 12. A preamplifier 9 receives the signals from the audio input 11, the telephone coil 12 and the microphone 10. The preamplifier 9 also has an A/D converter and a voltage controller.

A digital signal processing unit 8 with a clocked final stage receives the signal of the preamplifier 9. The preamplifier 9 and signal processing unit 8 are powered by way of a battery 13. A volume controller 5 for volume regulation and a programming socket 14 for programming the hearing device 1 are also connected to the digital signal processing unit 8. The digital signal processing unit 8 can be switched into a microphone mode of operation or a telephone mode of operation by way of an MTO switch 6, and the hearing device 1 can be turned off.

An identification module 15 is also integrated in the signal processing unit 8. This analyses the signals above the acoustic useful spectrum for instance and can thus detect and evaluate an identification signal 21 emitted by an external acoustic source 16 in the ultrasound frequency range for instance.

The telephone coil 12 can optionally receive an identification signal 21 emitted by an external acoustic source 16, which is then evaluated by the identification module 15.

As the identification signal 21 specifies the type of external acoustic source 16, the identification module 15 can, on the basis of the analysis of the identification signal 21, trigger the signal processing unit 8 to switch into the mode of operation which corresponds to the acoustic source type. All different possible identification signals 21 are stored in a memory of the identification module 15 for an evaluation.

In the signal processing unit 8, the signal of the preamplifier 9 is processed according to the mode of operation, also known as program, which is selected manually or automatically, and/or processes the signal processing parameters selected as a result. The resulting output signal is forwarded to a receiver 7. Alternatively, electrodes, moving coils, vibration sensors etc. are provided as output units.

FIG. 4 shows an arrangement for implementing the inventive method as claimed in FIG. 1 with a hearing device 1, configured according to FIG. 3, and a telephone handset 16 as an external acoustic source. An MTO switch, a telephone coil 12 and a microphone 10 are integrated in the hearing device 1. The telephone handset 16 includes a user station 17 for connection to a public telephone network (not shown), a telephone receiver cord 18 connected to the user station 17, an anti-twist device 20 and a telephone receiver 19. The anti-twist device 20 is arranged between the telephone receiver 19 and telephone receiver cord 18 and prevents an unwanted twisting of the telephone receiver cord 18. An inventive identification generation apparatus (not shown) is integrated in the anti-twist device 20, said identification generation apparatus being powered by way of the remote power supply of the telephone handset 16. An identification signal 21 generated by the identification generation apparatus is reproduced as an acoustic signal by way of the telephone receiver 19 and can thus be received by the microphone 10 of the hearing device 1.

The identification signal 21 specifies the type of external acoustic signal source 16, in this exemplary embodiment the type “telephone”. This is carried out for instance by means of an inaudible, acoustic signal with a pulse frequency of 20 kHz and a pulse width of 50 μs.

The type “audio” can be specified for instance by an acoustic signal with 18 kHz and 75 μs pulse width.

In another embodiment, the identification signal 21 can be an electromagnetic signal, which is received by the telephone coil 12 of the hearing device 1.

The identification signal 21 output by the telephone receiver 19 is detected by the hearing device 1 and evaluated according to the description in FIG. 3.

Identification generation apparatuses for generating the identification signal 21 can be integrated in all external acoustic sources 16 in any embodiments or can be connected thereto as an additional module. With mobile telephones, the identification generation apparatus can be integrated in a memory card as a software code for instance.

1-12. (canceled)

13. A method for detecting the type of external acoustic sources with a hearing device, comprising:
outputting an identification signal by the external acoustic source, the identification signal specifying the type of acoustic source;
detecting the identification signal by the hearing device; and
evaluating the identification signal in the hearing device, the identification signal evaluated for an identification of the type of acoustic source.

14. The method as claimed in claim 13, wherein a mode of operation of the hearing device is assigned to each type of acoustic source.

15. The method as claimed in claim 14, further comprises switching, by the hearing device, into the mode of operation associated with the identified type of acoustic source.

16. The method as claimed in claim 13, wherein the identification signal is an acoustic or electromagnetic signal.

17. The method as claimed in claim 16, wherein the type of acoustic source is identified from the pulse frequency and the pulse width of the identification signal.

18. The method as claimed in claim 17, wherein the external acoustic sources include at least a type selected from the group consisting of telephone device, audio device and MLX device.

19. The method as claimed in claim 13, wherein the external acoustic sources include at least a type selected from the group consisting of telephone device, audio device and MLX device.

20. A hearing device, comprising:
an identification module arranged in the hearing device such that an identification signal which is output by an external acoustic source and which specifies the type of acoustic source is detected and evaluated for identification of the type of acoustic source.

21. The hearing device as claimed in claim 20, wherein the type of acoustic source is determined by the identification module from the pulse frequency of the identification signal.

22. The hearing device as claimed in claim 20, wherein the type of acoustic source is determined by the identification module from the pulse width of the identification signal.

23. The hearing device as claimed in claim 20, wherein the type of acoustic source is determined by the identification module from the pulse frequency and pulse width of the identification signal.

24. The hearing device as claimed in claim 20, wherein a mode of operation of the hearing device is associated to the identified acoustic source, and wherein the hearing aid switches into the respective mode of operation.

25. An identification generation apparatus for an external acoustic source, wherein an identification signal that that identifies the type of acoustic source via the identification signal is generated.

26. The identification generation apparatus as claimed in claim 25, wherein the apparatus is integrated in an anti-twist device arranged between a telephone receiver and a telephone receiver cord.

27. The identification generation apparatus as claimed in claim 25, wherein the apparatus is integrated in a memory card of a mobile telephone.
